(19) United States
(12) Patent Application Publication
(10) Pub. No.: US 2007/0223948 A1
(43) Pub. Date: Sep. 27, 2007

(54) Developer degradation detection method and image forming device using same

(75) Inventor: Kenshi Matsui, Osaka (JP)

Correspondence Address: GLOBAL IP COUNSELORS, LLP, 1233 20TH STREET, NW, SUITE 700, WASHINGTON, DC, 20036-2680, US

(73) Assignee: KYOCERA MITA CORPORATION, Osaka (JP)

(21) Appl. No.: 11/723,363

(22) Filed: Mar. 19, 2007

(30) Foreign Application Priority Data
Mar. 22, 2006 (JP) JP 2006-078619

(51) Int. Cl. G03G 15/08

(52) U.S. Cl. 399/27

(57) ABSTRACT

Light is emitted from a light emitting unit towards the surface of the developing sleeve on which magnetic brushes are formed on the surface, and the reflected light is received by a light receiving unit. Then the percentage of reflected light is measured to detect degradation of the developer. When degradation of developer is detected, toner is transferred from the developing sleeve to the photosensitive drum when images are not being formed, and the degraded toner is discharged from the developing device.

### CROSS-REFERENCE TO RELATED APPLICATIONS

This application claims priority to Japanese Patent Application No. 2006-078619 filed on Mar. 22, 2006. The entire disclosure of Japanese Patent Application No. 2006-078619 is hereby incorporated herein by reference.

### BACKGROUND OF THE INVENTION

1. Field of the Invention

The present invention generally relates to a developer degradation detection method. More specifically, the present invention relates to a developer degradation detection method for the contacting two component developing system. Also, the present invention relates to an image forming device that uses this method.

2. Background Information

The developing systems of image forming devices such as facsimiles, printers, or multi-function printers are broadly classified into the two component developing system using magnetic carrier and toner, and one component developing system using magnetic toner or non-magnetic toner. To date the two component developing system has been widely used for the charging characteristics stability of the toner under all environments, the reproducibility of half tones, and so on.

When a two component developer has been used over a long period of time, and in particular when the agitation operation has been carried out intermittently for a long time with little toner consumption, white dots which are known as “beads carry over” occur on the toner images. This is caused by magnetic carrier being transferred to the photosensitive drum (image carrying member).

To prevent this type of defect, conventionally, for example, the number of sheets that can be printed before changing the developer is set in advance. When the number of sheets that can be printed has been exceeded, the user is encouraged to change the toner as the usable life of the developer has been reached. Also, in Japanese Utility Model Application Laid-open No. S63-14258, technology is proposed in which the current flowing in a developing sleeve from the photosensitive member is measured. When the current is equal to or less than a predetermined value, it is determined that the life of the developer has expired, and changing the developer is encouraged.

However, in the method of setting in advance the number of sheets that can be printed, the actual state of degradation of the developer does not necessarily correspond to the number of sheets printed. Therefore, although usable developer may still remain it is possible to determine that the life of the developer has expired and the developer is to be changed and discarded. Also, in the method of determining the life of the developer from the current flowing in the developer sleeve from the photosensitive member, it is considered that the life of the developer can be accurately determined by this method, but there is the problem that the device is made larger.

In view of the above, it will be apparent to those skilled in the art from this disclosure that there exists a need for an improved developer degradation detection method. This invention addresses this need in the art as well as other needs, which will become apparent to those skilled in the art from this disclosure.

### SUMMARY OF THE INVENTION

With the foregoing conventional problems in view, it is an object of the present invention to provide a method that accurately measures the life of developer, with a simple structure and without increasing the size of the device.

Also, it is an object of the present invention to provide an image forming device capable of obtaining good images over a long period of time without the occurrence of beads carry over.

It is a further object of the present invention to provide an image forming device for which the developer can be changed at the correct time.

A method of detecting developer degradation according to a first aspect of the present invention in a developing system uses magnetic brushes of a two component developer that includes magnetic carrier and toner. The magnetic brushes are formed on a developer carrying member that houses a magnetic pole member. The ends of the magnetic brushes contact the surface of an image carrying member, toner is transferred to the image carrying member, and latent images formed on the image carrying member become visible. The method includes emitting light towards the surface of the developer carrying member on which the magnetic brushes are formed, and measuring the percentage of reflected light to detect degradation of the developer.

Also, the image forming device according to the present invention includes a developing device and an image carrying member. The developing device has a developer carrying member that houses a magnetic pole member on which magnetic brushes of two component developer that includes magnetic carrier and toner are formed. The surface of the image carrying member is contacted by the ends of the magnetic brushes. Also when degradation of developer is detected by the method of detecting developer degradation according to the first aspect of the present invention, the developing device transfers toner from the developer carrying member to the image carrying member when images are not being formed, and discharges the degraded toner.

Furthermore, the image forming device according to the present invention includes a developing device, an image carrying member, and a notification device. The developing device has a developer carrying member that houses a magnetic pole member, on which magnetic brushes of two component developer that includes magnetic carrier and toner are formed. The surface of image carrying member is contacted by the ends of the magnetic brushes. The notification device notifies that the developer has degraded when degradation of developer is detected by the method of detecting developer degradation according to the first aspect of the present invention.

In the method of detecting developer degradation according to the present invention, light is emitted towards the developer carrying member at a position on the surface where magnetic brushes are formed on the surface, and the percentage of reflected light is measured. Then degradation of the developer is detected from the percentage of reflected light so that the life of the developer can be accurately measured with a simple structure and without increasing the size of the device.

Also, in the image forming device according to the present invention, when degradation of developer is detected by the method of detecting developer degradation described above, toner is transferred from the developer carrying member to the image carrying member when images are not being formed, and the degraded toner is discharged from the developing device. Therefore, beads carry over does not occur, and good images can be produced over a long period of time.

Furthermore, in the image forming device according to the present invention, a notification device is provided that notifies that the developer has degraded when degradation of developer is detected by the method of detecting developer degradation described above. Therefore, it is possible to change the developer at the correct time, and good images can be obtained over a long period of time.

These and other objects, features, aspects, and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is an external view showing an image forming device according to a preferred embodiment of the present invention;

FIG. 2 is a schematic cross-sectional diagrammatical view showing the main parts of the interior of the image forming device of FIG. 1;

FIG. 3 is an enlarged schematic cross-sectional diagrammatical view of the developing device used in the image forming device of FIG. 1;

FIG. 4 is a partial schematic cross-sectional view of a magnetic brush formed on the surface of a developing sleeve of the developing device;

FIG. 5 is a view of a diagram showing toner particles embedded in surface treatment material;

FIG. 6A is a cross-sectional diagrammatic view showing magnetic brushes on the surface of the developing sleeve;

FIG. 6B is a cross-sectional diagrammatical view showing magnetic brushes on the surface of the developing sleeve;

FIG. 7 is a view of a graph showing the relationship between the number of magnetic brushes and the reflectivity;

FIG. 8 is a partial cross-sectional schematic diagrammatical view illustrating a detection method and the image forming device according to the preferred embodiment of the present invention; and

FIG. 9 is a plan view showing a notification device of the image forming device according to the preferred embodiment of the present invention.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

The following is an explanation of the present invention based on the drawings. However, the present invention is not limited to these embodiments.

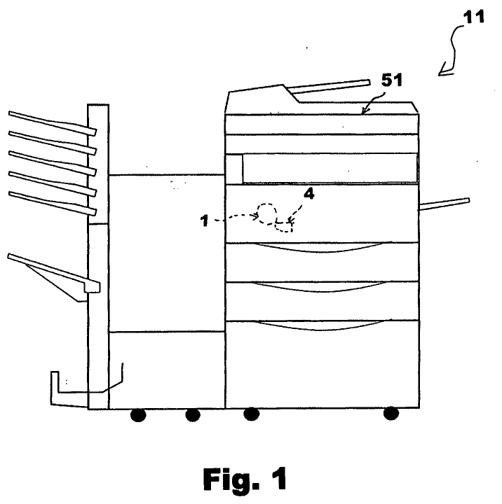

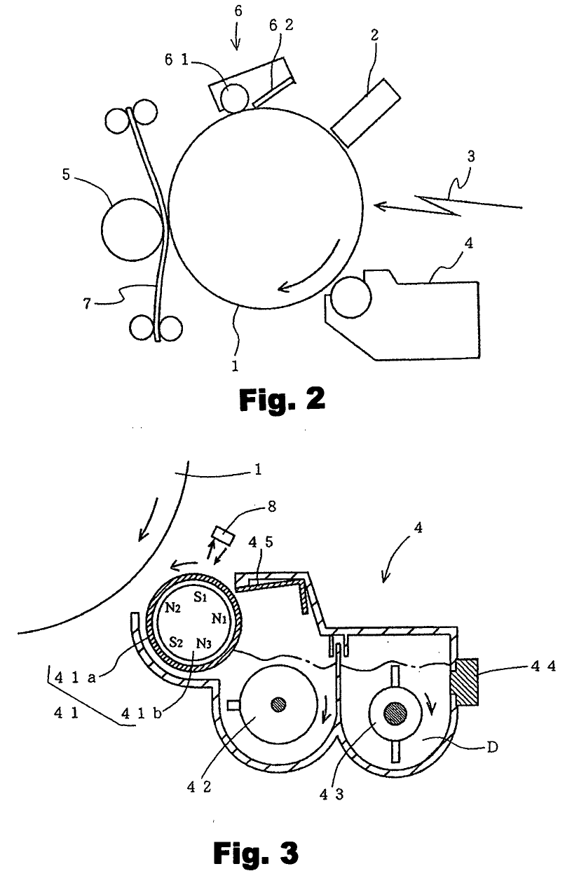

FIG. 1 is an external view showing an image forming device 11 according to a preferred embodiment of the present invention. Also, FIG. 2 is a schematic diagrammatical view showing the main parts of the interior of the image forming device 11. In the image forming device 1, the surface of a photosensitive drum (image carrying member) 1 is uniformly charged by a charging device 2. Next, an electrostatic latent image is formed on the surface of the photosensitive drum 1 by a light exposure device 3. Then toner is applied to the electrostatic latent image to make the image visible. A developing device 4 that is described later is used to apply the toner. In a transfer device 5, the toner image on the surface of the photosensitive drum 1 is transferred to a transfer member 7. Then heat and pressure are applied to the toner image on the transfer member 7 by a fixing device that is not shown on the drawings, which melts and fixes the toner image to the transfer member 7. Toner that is not transferred and that remains on the photosensitive drum I is initially cleaned by a cleaning brush 61, and then finally cleaned by a cleaning blade 62 in a cleaning device 6.

FIG. 3 is an enlarged cross-sectional view of the developing device 4 of the image forming device 11. The developing device 4 includes a developer carrying member 41 arranged opposite the photosensitive drum 1. The developer carrying member 41 includes a magnetic roller (magnetic pole member) 41b within and fixed to a developing sleeve 41a, a spiral shaped first agitation and transport member 42, and a similar spiral shaped second agitation and transport member 43. A magnetic pole N₂ is disposed on the magnetic roller 41b within the developing sleeve 41a at a position in opposition to the photosensitive drum 1. Then from the magnetic pole N₂, the magnetic pole S₂, the magnetic pole N₃, the magnetic pole N₁, and the magnetic pole S₁ are disposed in the direction of rotation of the developing sleeve 41a. Thus, the magnetic pole member preferably has a plurality of magnetic poles.

A blade 45 that regulates the quantity of developer D that is transported is disposed in opposition to a position between the magnetic pole N₁ and the magnetic pole S₁ of the magnetic roller 41b, and separated from the developer carrying member 41. Also, a toner sensor 44 that measures the quantity of toner is disposed in a side wall to the right hand side of the second agitation and transport member 43. When the toner sensor 44 detects that there is insufficient toner within the developing device 4, toner is supplied from a toner hopper (not shown in the drawings) to the developing device 4. The supplied toner is first transported while being agitated by the second agitation and transport member 43 from the front to rear direction in FIG. 3. At the end on the rear side the toner is transferred from the second agitation and transport member 43 to the first agitation and transport member 42. During this time, the toner is uniformly mixed with magnetic carrier. Also, the developer D that includes magnetic carrier and toner is transported while being agitated by the first agitation and transport member 42 from the rear to front direction in FIG. 3. During this time, the developer is supplied to the developing sleeve 41a as appropriate.

In other words, the developer that has been agitated by the first agitation and transport member 42 and the second agitation and transport member 43 is scooped up onto the developing sleeve 41a by the magnetic force of the magnetic pole N₁ of the magnetic roller 41b. Then the developer is transported by the rotation of the developing sleeve 41a to the gap between the blade 45 and the developing sleeve 41a. When the developer D passes this gap, the quantity of developer sent to the developing area is regulated. Also, the electrostatic latent image on the photosensitive drum 1 is developed by the developer D transported to the developing area which is the area in opposition to the photosensitive drum 1.

The method of developing the electrostatic latent image on the photosensitive drum I may be either the charged area developing method or the reversal developing method. The charged area developing method is a method in which the electrostatic latent image is developed with toner having charge of the opposite polarity to the portions of the photosensitive drum 1 that is not exposed to light. The reversal developing method is a method in which the electrostatic latent image is developed with toner having a charge of the same polarity as the portions not exposed to light. To obtain high quality images the reversal developing method is preferable. In this case, the photosensitive drum 1 is charged with the same polarity as the toner, and the charge is removed from the latent image portions by the exposure to light. Then in the developing area, a developing bias being made of an AC voltage superimposed on a DC voltage is applied between the developing sleeve 41a and the photosensitive drum 1. The toner in the developer D adheres to the electrostatic latent image on the photosensitive drum I for which the charge was removed, and the electrostatic latent image becomes visible as a toner image. On the other hand, developer D that has passed the developing area is separated from and falls away from the developing sleeve 41a by the repulsive force between the magnetic pole N₂ and the magnetic pole N₁. Then new developer D is scooped up onto the developing sleeve 41a from the agitation area, as described previously.

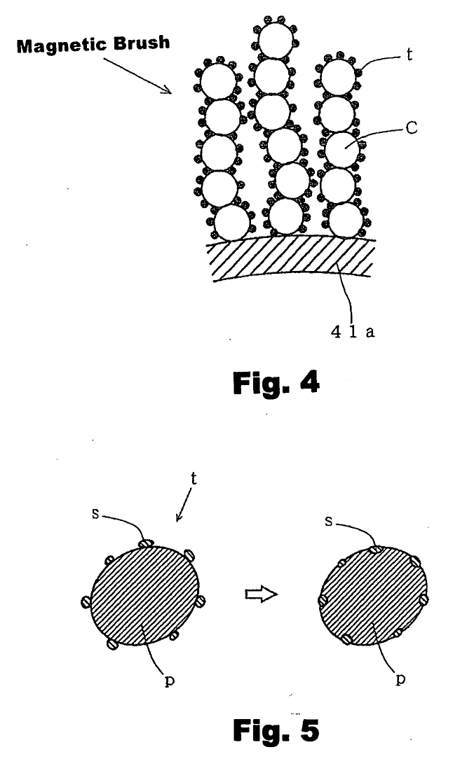

As shown in FIG. 4, the developer D scooped up onto the developing sleeve 41a forms magnetic brushes in which a plurality of magnetic carrier particles C with toner adhering to the surface thereof become aligned on the surface of the developing sleeve 41a as a result of the magnetic force of the magnetic roller 41b. It should be apparent from this disclosure that magnetic brushes form only during an image forming operation using the developing sleeve 41a and are not formed during a power off state.

The magnetic carrier C used in the present invention may be a resin covered carrier, non-covered carrier, resin carrier, or another conventionally known carrier. In the case of a resin covered carrier, the carrier core material may be Mn—Mg, Cu—Zn, Li, Mg, or another ferromagnetic material. The covering resin material may be a fluorine, silicone, acrylic, or another type of thermosetting resin. There is no particular limitation on the particle diameter of the magnetic carrier, but the range 20 to 100 μm is preferable. A more preferable range is 30 to 60 μm.

The toner t used in the present invention may be polyester toner, styrene toner, or another conventionally known toner. Additives contained in the toner particles may include charge control agents such as quaternary ammonium salts or nigrosin dye; paraffin, carnauba, olefin, or a similar wax; and coloring agents such as carbon black or various pigments or dyes. Also, surface treatment agent material added to the surface of the toner particles may include silica, titanium oxide, alumina, or other charge control agents. Also, it is preferable that 0.5 to 10 wt % charge control agent, 1 to 10 wt % wax, 1 to 10 wt % coloring agent be added. It is preferable that the toner average volumetric particle diameter is within the range of 4 to 12 μm, or more preferably 5.5 to 9.5 μm.

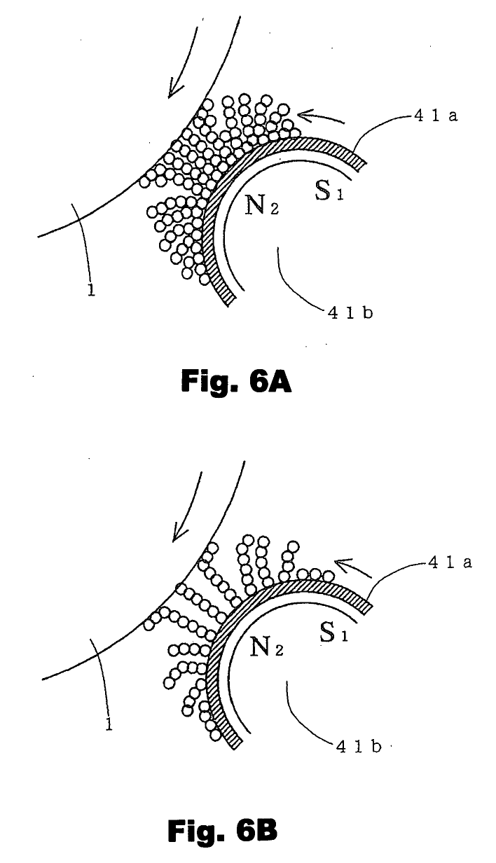

In this type of developing device, when two component developer is used over a long period of time, in particular when the consumption of toner is small and the agitation operation is carried out for a long time, the surface treatment material s such as silica or the like on the surface of the toner particles p becomes embedded within the toner particles p, as shown in FIG. 5. As a result the fluidity of the developer D is reduced. If the fluidity of the developer D is reduced, the supply of developer D from the agitation area to the developing sleeve 41a in the developing device 4 is reduced so that the quantity of developer on the surface of the developing sleeve 41a is reduced. In this way, as shown in FIGS. 6A and 6B, the number of magnetic brushes in the developing area becomes fewer (FIG. 6B) than normal (FIG. 6A).

If the number of magnetic brushes in the developing area is reduced, the value of the current flowing in each brush increases, the magnetic carrier C is transferred to the photosensitive drum 1, and white spots occur on the toner image, which is known as “beads carry over.”

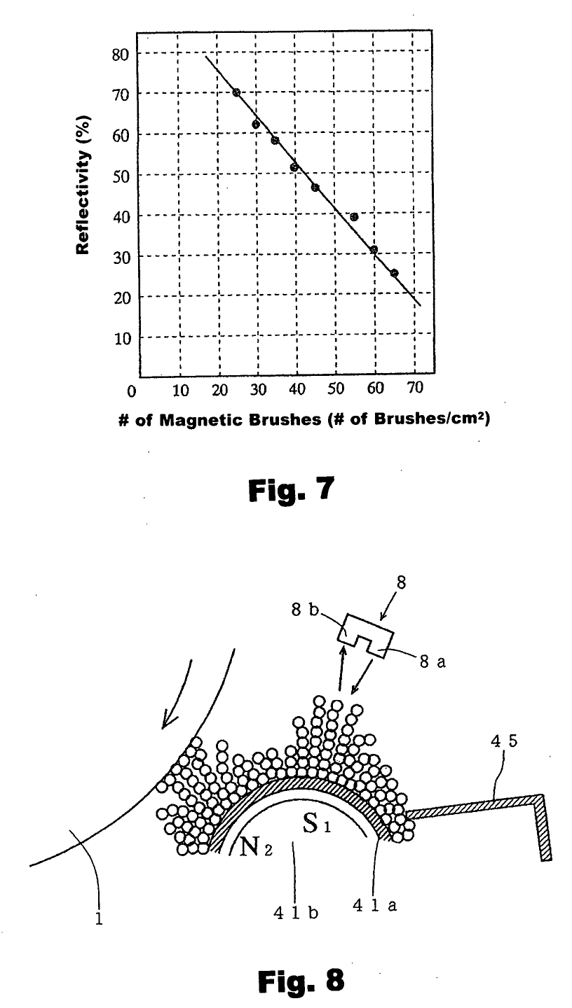

As a result of diligent research into preventing this type of defect, the inventors of the present invention discovered that the number of magnetic brushes is inversely proportional to rate of reflection of light that illuminates the developing sleeve. FIG. 7 is a graph showing the correlation between the number of magnetic brushes per unit area on the surface of the developing sleeve and the reflectivity of light that illuminates the developing sleeve.

As can be understood from this graph, the more magnetic brushes the lower the reflectivity of the light, and the fewer the magnetic brushes the higher the reflectivity of the light. This is because when the number of magnetic brushes is large the illuminating light cannot reach the surface of the developing sleeve, thus, the light reflectivity is reduced. However, when the number of magnetic brushes is small, the illuminating light reaches the surface of the developing sleeve, thus, the amount of reflected light is larger. By using this correlation between the number of magnetic brushes and the light reflectivity it is possible to measure indirectly the variation in the number of magnetic brushes by measuring the light reflectivity of the surface of the developing sleeve. This correlation varies depending on the developing sleeve diameter and material, magnetic carrier particle diameter, magnetic force of the magnetic poles, and so on. Therefore, it is necessary to measure the correlation in advance for each developing device.

Therefore, as shown in FIG. 8, a light emitting unit 8a that emits light, and a light receiving unit 8b are provided. The light emitting unit 8a is provided in a location where the magnetic brushes rise up from the developing sleeve 41a. In other words, the light emitting unit 8a is provided in a location where the magnetic lines of force from the magnetic poles of the magnetic roller 41b within the magnetic sleeve 41a are normal to the surface of the developing sleeve. The light receiving unit 8b is provided in a location where the light reflected from the developing sleeve 41a can be received In this way, it is possible to measure the percentage of the light reflected when magnetic brushes are formed on the surface of the developing sleeve 41a. Of course, if it were possible it would be ideal to illuminate with light and measure the reflected light at a position from outside in the radial direction at the developing magnetic pole N₂. However, the photosensitive drum 1 is located at a position in opposition to the developing area of the developing sleeve 41a, thus, there would be many difficulties in installing the members to emit and to receive the light in this location. Therefore, it is practical to install the light emitting and receiving members 8a and 8b at a position on the outside in the radial direction at another magnetic pole (at magnetic pole S₁ in FIG. 8) where the magnetic brushes rise up. In the embodiment shown in the figure, a photointerruptor 8 arranged opposite the developer carrying member 41 in one direction and opposite the photosensitive drum 1 in a second direction, is used in which the light emitting unit 8a and the light receiving unit 8b are integrated.

In the method to measure degradation of developer as explained above, when the reflectivity increases it is determined that the developer (toner) has degraded, thus, the degraded toner is removed from the developing device. The method of removing the degraded toner from the developing device can be for example to transfer the toner on the developing sleeve to the photosensitive drum 1 when not forming images, and collecting the toner with the cleaning device 6. Also, the amount of consumed toner can be newly supplied from the hopper. Specifically, in the case of the reversal developing method, after the photosensitive drum is uniformly charged by the charging device, the photosensitive drum is exposed to light by the light exposure device to reduce the charge on the photosensitive drum. Also, a developing bias is applied to the developing device, thus, the toner on the developing sleeve is transferred to the area of the photosensitive drum on which the charge is reduced. In this way, most of the degraded toner is transferred to the photosensitive drum. Also, in the charged area developing method, after uniformly charging the photosensitive drum by the charging device, developing is carried out by the developing device without exposing the photosensitive drum to light, to transfer the toner on the developing sleeve to the photosensitive drum.

It is possible to adjust the quantity of degraded toner transferred to the photosensitive drum using the developing bias applied to the developing sleeve and the surface potential of the photosensitive drum. If the surface potential of the photosensitive drum is constant, the larger the developing bias the more degraded toner is transferred to the photosensitive drum. As an approximate guide to the quantity transferred, if the reflectivity is 50% or greater, it is determined that the toner is severely degraded, and about 4 mg of toner is consumed in an A4 size developing area. If the reflectivity is 30 to 50%, about 2 mg of toner is consumed in an A4 size developing area. If the reflectivity is less than 30%, it is determined that the degradation of toner is low, so transfer of toner to the photosensitive drum when images are not being formed is not carried out.

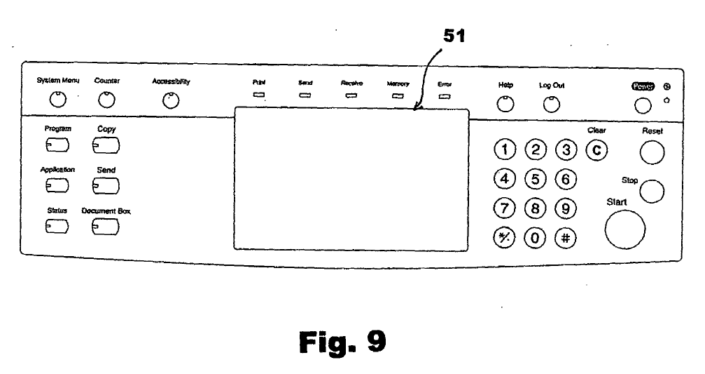

The method of removing the degraded toner from the developing device may be a method of replacing the developer in the developing device. The developer being made of magnetic carrier and toner within the developing device may be all discarded, and new developer inserted. Alternatively, the developer may be removed from the developing device, then using a dust extractor and sieve or the like, the toner is selectively removed from the developer. Then new toner is added to the existing carrier, agitated, and added to the developing device as new developer. In each case the operation of replacing the developer must be carried out by service personnel or users. Therefore it is desirable to provide on the image forming device 11, a display screen 51 (notification device) as shown in FIG. 9, or a notification device that makes a sound, lights a light, or flashes a light when degradation of the developer is detected, to communicate to the service personnel or user that the time for replacing the developer has arrived.

The term “configured” as used herein to describe a component, section or part of a device includes hardware and/or software that is constructed and/or programmed to carry out the desired function.

Moreover, terms that are expressed as “means-plus function” in the claims should include any structure that can be utilized to carry out the function of that part of the present invention.

### General Interpretation of Terms

In understanding the scope of the present invention, the term “configured” as used herein to describe a component, section or part of a device includes hardware and/or software that is constructed and/or programmed to carry out the desired function. In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers, and/or steps. The foregoing also applies to words having similar meanings such as the terms, “including,” “having,” and their derivatives. Also, the terms “part,” “section,” “portion,” “member,” or “element” when used in the singular can have the dual meaning of a single part or a plurality of parts. As used herein to describe the present invention, the following directional terms “forward, rearward, above, downward, vertical, horizontal, below, and transverse” as well as any other similar directional terms refer to those directions of an image forming device equipped with or using the present invention. Accordingly, these terms, as utilized to describe the present invention should be interpreted relative to an image forming device equipped with or using the present invention as normally used. Finally, terms of degree such as “substantially,” “about,” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A method of detecting developer degradation, comprising:
preparing a developing system using a two component developer having a developer carrying member having magnetic brushes of magnetic carrier and toner formed thereon, the developer carrying member housing a magnetic pole member, the ends of the magnetic brushes contacting a surface of an image carrying member to transfer toner to the image carrying member to form and to make visible latent images on the image carrying member;
emitting light towards the surface of the developer carrying member having the magnetic brushes;
measuring the percentage of reflected light to detect degradation of the developer; and
displaying a warning when the developer has degraded.

2. The method of detecting developer degradation according to claim 1, further comprising
transferring toner from the developer carrying member to the image carrying member when images are not being formed, and the degraded toner is discharged.

3. The method of detecting developer degradation according to claim 1, wherein displaying the warning includes using a notification device that notifies that the developer has degraded when degradation of developer is detected.

4. An image forming device, comprising:
a developing device having
a developer carrying member housing a magnetic pole member, and
magnetic brushes being formed on a surface of the developing carrying member by two component developer;
an image carrying member having a surface being contacted by ends of the magnetic brushes; and
a detection unit having
a light emitting unit being configured to emit light towards the surface of the developer carrying member having the magnetic brushes, and
a light receiving unit being configured to measure the percentage of reflected light to detect degradation of the developer.

5. The image forming device according to claim 4, further comprising a notification device that notifies that the developer has degraded.

6. The image forming device according to claim 5, wherein the developing device further includes a blade that regulates the quantity of developer, and the detection unit is arranged between the blade and the image carrying member.

7. The image forming device according to claim 6, further comprising a cleaning device configured to remover degraded toner that has been transferred from the developer carrying member from the image carrying member when images are not being formed.

8. The image forming device according to claim 4, further comprising a cleaning device configured to remover degraded toner that has been transferred from the developer carrying member from the image carrying member when images are not being formed.

9. The image forming device according to claim 4, wherein the magnetic brushes form on the surface of the developing carrying member only during an image forming operation.

10. The image forming device according to claim 4, wherein the developing carrying member is arranged opposite to the image carrying member, and the magnetic pole member has a plurality of magnetic poles, and wherein the detection unit is arranged opposite the image carrying member in one direction and opposite the developing carrying member in a second direction.
